(19) United States
(12) Patent Application Publication
(10) Pub. No.: US 2025/0165680 A1
(43) Pub. Date: May 22, 2025

(54) Three-Dimensional Displacement Using Pre-Trained Physics Informed Neural Networks

(71) Applicant: Halliburton Energy Services, Inc., Houston, TX (US)

(72) Inventors: K V V N Krishna Babu Yerubandi, Houston, TX (US); Anoop Sheshrao Jogdand, Pune (IN); Walmy Cuello Jimenez, Houston, TX (US)

(73) Assignee: Halliburton Energy Services, Inc., Houston, TX (US)

(21) Appl. No.: 18/514,192

(22) Filed: Nov. 20, 2023

(51) Int. Cl. G06F 30/27; G06F 30/28; G06F 113/08

(52) U.S. Cl. CPC G06F 30/27; G06F 30/28; G06F 2113/08

(57) ABSTRACT

In general, in one aspect, embodiments relate to a method that includes providing a pre-trained Physics-Informed Neural Networks (PINNs), providing one or more inputs to the one or more pre-trained PINNs, generating a time-varying predicted displacement using the one or more PINNs, comparing the time-varying predicted displacement with a target displacement, adjusting at least one of the one or more inputs and repeating the step of generating until the time-varying predicted displacement converges to the target displacement, and performing a cementing operation based at least in part on the one or more adjusted inputs.

### BACKGROUND

In subterranean well construction, a pipe string (e.g., casing, liners, expandable tubulars, etc.) may be run into a wellbore and cemented in place. The process of cementing the pipe string in place is commonly referred to as “primary cementing.” In a typical primary cementing method, cement may be pumped into an annulus between the walls of the wellbore and the exterior surface of the pipe string disposed therein. The cement composition may set in the annular space, thereby forming an annular sheath of hardened, substantially impermeable cement (i.e., a cement sheath) that may support and position the pipe string in the wellbore and may bond the exterior surface of the pipe string to the subterranean formation. Among other things, the cement sheath surrounding the pipe string prevents the migration of fluids in the annulus and protects the pipe string from corrosion. Cement may also be pumped into wellbore during, for example, remedial cementing methods to seal cracks or holes in pipe strings or cement sheaths, to seal highly permeable formation zones or fractures, or to place a cement plug and the like.

During the design phase of a cementing operation, it is often difficult to predict how cement and other fluids will behave spatially within the wellbore. Traditionally, three-dimensional computer modelling techniques have been used to predict displacement of cement with respect to the other fluids, however, these techniques are typically computationally expensive to perform, especially for wellbores having complex geometries.

### BRIEF DESCRIPTION OF THE DRAWINGS

These drawings illustrate certain aspects of some of the embodiments of the present disclosure and should not be used to limit or define the disclosure.

FIG. 1 illustrates a schematic of a workflow for predicting displacement of fluid in a wellbore, in accordance with one or more examples.

FIG. 2 illustrates a schematic of a part of a workflow for predicting displacement profile of fluid in a wellbore, in accordance with one or more examples.

FIG. 3 illustrates a wellbore having a complex geometry, in accordance with one or more examples.

FIG. 4 illustrates a wellbore divided into a plurality of annular cross-sections, in accordance with one or more examples.

FIG. 5 illustrates an input and output of a single annular cross-section of a wellbore, in accordance with one or more examples.

FIG. 6 illustrates a workflow which uses physics informed neural networks to predict velocity fields of fluids of an annular cross-section of a wellbore, in accordance with one or more examples.

FIG. 7 illustrates a workflow which uses physics informed neural networks to predict velocity fields of a wellbore, in accordance with one or more examples.

FIG. 8 illustrates timelines comparing computation speed of a three-dimensional displacement model and a model which uses physics informed neural networks, in accordance with one or more examples.

FIG. 9 illustrates an information handling system, in accordance with one or more examples.

FIG. 10 illustrates an information handling system, in accordance with one or more examples.

FIG. 11 illustrates an arrangement of resources in a computing network, in accordance with one or more examples.

### DETAILED DESCRIPTION

Disclosed herein are systems and methods for designing cementing operations. Particularly disclosed herein are systems and methods for computer-modelling the fluid dynamics of wellbore fluids. More particularly, disclosed herein are methods and systems which use Physics Informed Neural Networks (PINNs) to output fluid dynamic predictions during the design phase of a cementing job.

In transient fluid flow problems, such as when predicting displacement of fluids in wellbores during cementing, it is often time-consuming for a computer to solve for velocities and pressures of fluid in wellbores when fluid profile and boundary conditions are given. For example, fluid flow may be determined using projection algorithms which provide solutions for incompressible Navier-Stokes equations, which may be implemented using numerical methods (e.g., finite volume or finite difference schemes). However, because these types of methods often require discretization of space and time domains into smaller elements and volumes, the process of finding a solution becomes time-consuming. For example, some methods may require solving prime velocities, solving corrected pressures based on prime velocities, and correcting calculated velocities based on corrected pressures.

PINNs, or Physics-Informed Neural Networks, are a class of machine learning techniques used to solve partial differential equations (PDEs), which use neural networks and physics equations to learn and predict solutions of complex physical systems. In this disclosure, PINNs are used to directly predict the complex fluid dynamics of wellbores during cementing jobs without requiring these time-consuming steps, thereby greatly reducing the amount of time needed to solve for these and other parameters.

Thus, implementation of one or more PINNs as described herein may reduce the computation cost and run-time of systems that predict displacement and/or other fluid parameters of the wellbore fluids. Such parameters may involve, to use non-limiting examples, velocity, concentration, pressure, and/or other time-varying and/or spatially varying outputs of the fluid dynamics in wellbores. In addition, this reduction in run-time may, in some examples, also allow simulations to be performed on cloud computing platforms and may allow simulations to be performed in real-time, in some examples. This may allow engineers to run more predictions, and visualize, in real-time, the output simulations, ultimately enabling them to make better decisions when creating a job plan for a cementing operation.

“Real-time” as used herein refers to a system, apparatus, or method in which a set of input data is processed and available for use within 100 milliseconds (“ms”). In further examples, the input data may be processed and available for use within 90 ms, within 80 ms, within 70 ms, within 60 ms, within 50 ms, within 40 ms, within 30 ms, within 20 ms, or any ranges therebetween. In some examples, real-time may relate to a human's sense of time rather than a machine's sense of time. For example, processing which results in a virtually immediate output, as perceived by a human, may be considered real-time processing.

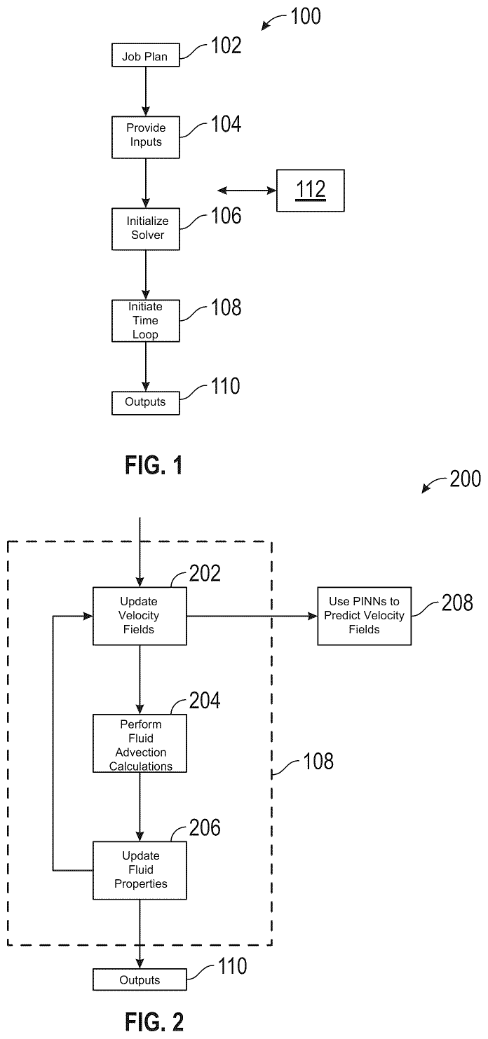

As mentioned above, the methods and systems of the present disclosure are exemplary and are not intended to limit the scope of the present invention. Thus, the specific workflows (e.g., workflows 100, 500, 700 of FIGS. 1, 5, 7) described by this disclosure may be adapted to suit a particular application, such as by rearranging, omitting, or adding intervening operations and/or blocks between the various actions performed by the workflows.

FIG. 1 illustrates a schematic of a workflow 100 for predicting displacement of fluid in a wellbore, in accordance with one or more examples. Workflow 100 begins at block 102 where a job plan is provided. A job plan may include one or more design parameters of a cementing operation which may include composition of a cement, pumping schedule, pumping rate, volume, anticipated duration of the cementing operation, type of job (e.g., primary cementing, balanced plug job, etc.), type of fluid circulation (e.g., forward, reverse), choice of wellbore casing (e.g. type, size, etc.), type of centralizers, spacing of the various wellbore equipment (e.g., centralizers), casing movement (e.g., reciprocation, rotation, etc.), to use non-limiting examples. The job plan provides a basis for later predictions, as actual implementing the design parameters materially affects how the wellbore fluids will be displaced, time-dependent fluid concentration, or other fluid properties arising out of interactions between the wellbore and wellbore fluid during a cementing job. A job plan may also comprise a target displacement of a cement and/or one or more wellbore fluids. Where used, the target displacement may guide workflow 100 to modify inputs, re-run one or more operations of the workflow (e.g., predictions by one or more PINNs), etc., until one or more predictive outputs of the workflow 100 match the target displacement. Other design parameters may be similarly used, such as target velocity, target concentration, combinations thereof, or the like.

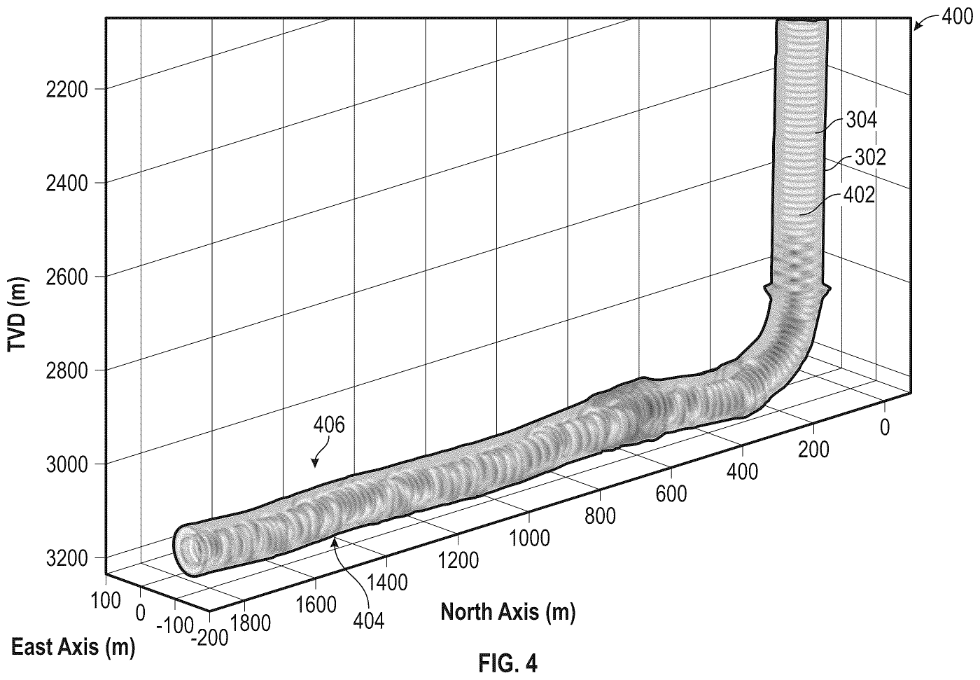

At block 104, inputs are provided. Inputs of the various workflows disclosed herein may comprise wellbore data, such as data gathered from one or more sensors disposed in a wellbore (e.g., wellbore 302 of FIG. 3). The wellbore data may additionally, or alternatively, comprise information about a wellbore's geometry and/or geometry of one or more casings disposed therein. In embodiments, the wellbore data includes data gathered from logging including wireline logging and measurement while drilling. In other embodiments, the wellbore data include data gathered from a distributed acoustic sensing fiber optic line. Inputs may comprise, or be derived from, one or more design parameters of the job plan in block 102. In some examples, inputs may comprise an inner radius array, an outer radius array, wellbore length, wellbore diameter as a function of depth, combinations thereof, or the like. Inputs may include, for example, fluid properties (e.g., density, rheology, viscosity, etc.) of a cementing slurry, for example. Where used, fluid property inputs may comprise vectors, arrays, matrices, or data representing a particular fluid relative to a spatial orientation, for example, as viscosity on a three-dimensional grid and/or density on a three-dimensional grid. Inputs may comprise a gravity array, and/or one or more fixed parameters (e.g., grid size). Inputs of block 104 may be directly input, e.g., by an engineer, or be automatically determined by the software based on the job plan of block 102 and/or wellbore data. In one or more examples, one or more, e.g., all of, the inputs of block 104 may be used as inputs to the one or more PINNs.

In block 106, a solver is initialized. The solver iteratively converges to a solution using, for example, numerical methods. This may, in some examples, provide a preliminary basis for one or more operations of block 108. As used herein, “solver” refers to a tool which determines numerical solutions using a projection algorithm, which is implemented using a finite difference method. The solver of block 106 generates a mesh, or discretized domain for the wellbore, allocates memory for each variable array (e.g., velocity, pressure, concentration, etc.), and initializes the problem using pre-specified boundary conditions. After the solver is initialized, time marching for the transient problem is performed.

In block 108, a time loop is initiated, which may be used to produce one or more outputs. This may involve, in some examples, calculating outputs at each of a plurality of annular cross-sections and stitching together the outputs to render a three-dimensional representation of fluids in a wellbore. The outputs may be calculated for a plurality of timepoints within a timespan. Specifically, the time loop performs each of the sub-steps of the projection algorithm mentioned in block 106. These sub-steps include solving for prime velocities, pressure correction, and correcting the prime velocities to obtain actual velocities in subsequent time steps. During each time step, the solver iterates across a plurality of annular cross sections to render a finite difference solution. The number of annular cross sections used in a particular time loop may be, in some examples, the result of a separate discretization process.

Block 110 comprises the one or more outputs of block 108, which may include, for example, viscosity fields, density fields, displacement, fluid velocity, combinations thereof, and the like. The output in block 110 may represent time-varying and/or spatially-varying properties of one or more wellbore fluids within a wellbore. The output(s) of block 110 may be used to profile a wellbore or one or more segmented intervals thereof. For example, predicted velocity of a wellbore fluid may be calculated along a vertical axis, horizontal axis, and/or radial position of each annular cross-section of a wellbore such that the velocity of the wellbore fluid is modeled within three-dimensional space. The output of block 110 may additionally, or alternatively, comprise volume, pressure, and/or fluid concentration. These outputs may comprise one or more vectors, arrays, matrices, and/or other data which may, in some examples, represent these outputs for a plurality of time-varying and/or spatially-varying locations (e.g., along any or all of x, y, and z axes). As illustrated, one or more operations of any of the blocks of workflow 100 may be performed by, or in communication with, an information handling system 112, to be discussed in greater detail.

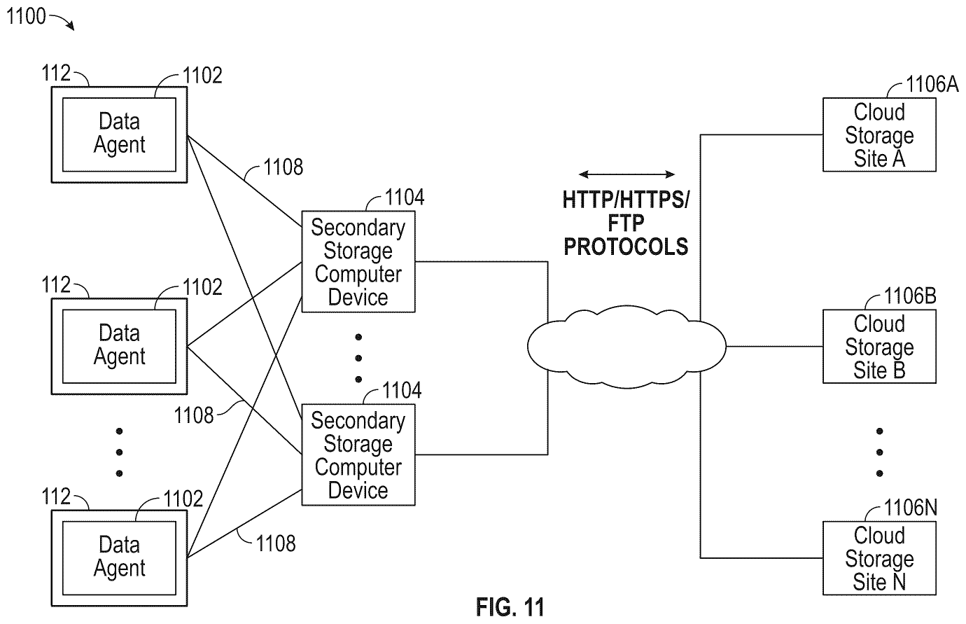

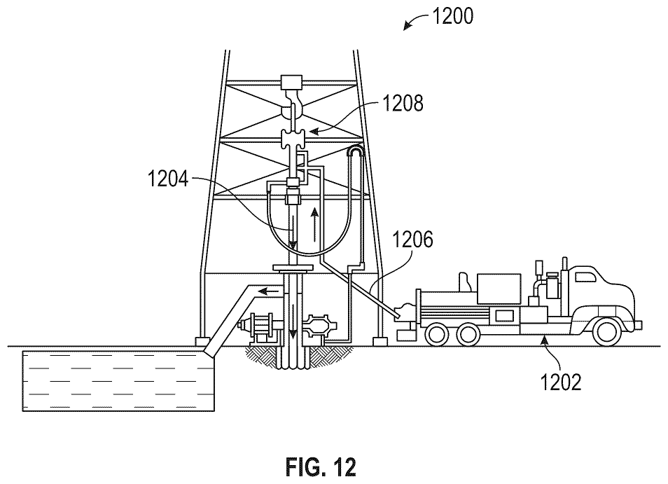

The one or more outputs of block 110 may be displayed on a display device (e.g., output device 92 of FIGS. 9, 10) from a cloud computing environment using information handling system 112, for example. Displaying output from a cloud computing environment may involve deploying software on cloud computing platforms, which may allow personnel to take advantage of the scalability and elasticity of a cloud computing environment. This may further speed up the calculations, ultimately allowing personnel to simulate three-dimensional displacement problems in real-time, and more quickly than would be typically possible using traditional techniques. In examples, an engineer may change a virtual design parameter, data, or other input to workflow 100 (e.g., to the one or more PINNs) via interactions with a graphical user-interface on a display device. Such interactions may trigger additional iterations of the generative output using the one or more PINNs. Generating output using the one or more PINNs may be performed in a cloud computing environment, and the output (e.g., a three-dimensional rendered model) representing at least a portion of the wellbore may be reproduced, in real-time, on the display device. This real-time availability of predictive output ultimately allows personnel to make better decisions about future and/or on-going cementing or other wellbore operations.

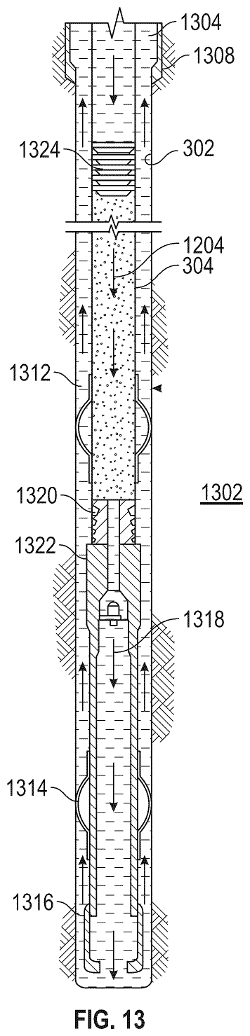

A cloud computing environment may involve virtualized hardware and/or virtualized software, in some examples. This may involve creating an abstraction layer between physical computing resources (e.g., servers, storage, networks, cloud storage sites 1106A-N of FIG. 11, etc.) and an application or service run on them. Abstraction layers may enable more efficient and flexible use of these resources, in some examples, as well as provide scalable and on-demand delivery of computing resources and services over a network (e.g., the internet). This allows users, in some examples, to access and utilize virtualized hardware, software, and storage from remote data centers. A virtual hardware may comprise a virtual machine mimicking physical hardware, which may be run on multiple operating systems and applications, isolated from one another, and on a single physical server. This may allow for improved resource allocation, management, and isolation in some examples, thereby making it possible to run different workloads on the same physical hardware without interference, in some examples.

In addition, personnel may rely on these real-time, cloud-ready predictions to gauge sensitivity of an operation to slight, or large, changes to the virtual design parameters of the operation. Rapid rendering of accurate predictions in real-time on a display device may thus allow for sensitivity analysis. For example, an engineer may increase the pump rate in a simulation by a specified margin and then quickly ascertain the extent to which displacement of a fluid occurs in the wellbore after an amount of time. In another example, an engineer may specify a target displacement, and the pump rate required to achieve the target displacement may be quickly rendered using the real-time, cloud-ready predictions.

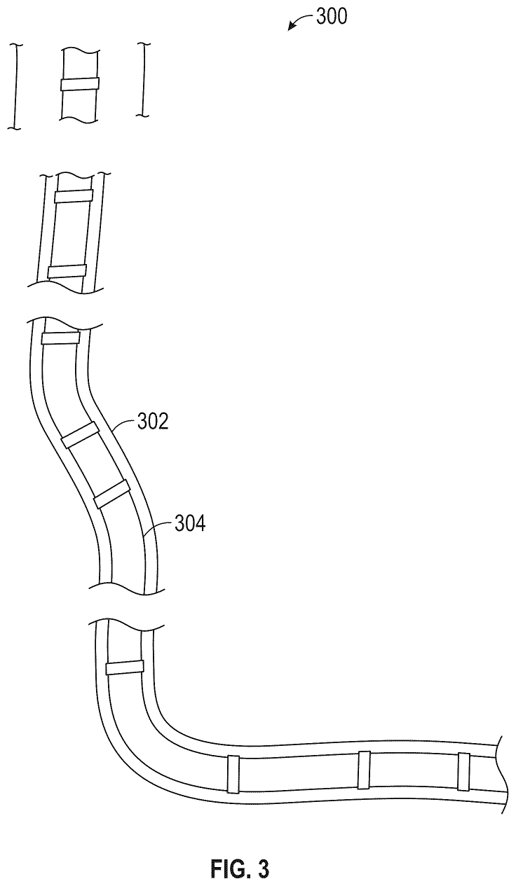

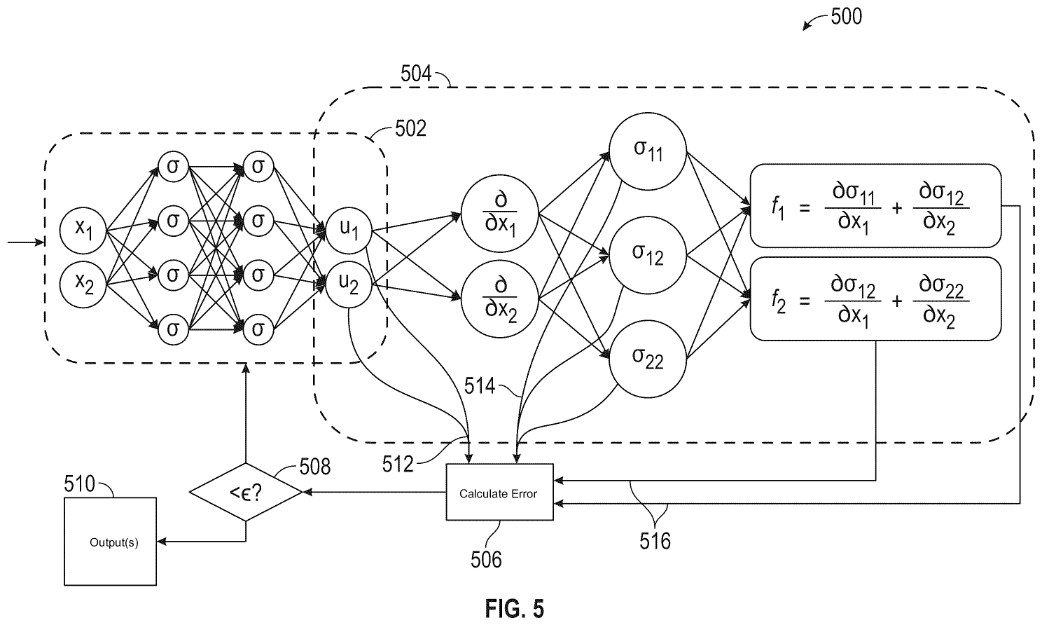

FIG. 2 illustrates a schematic of a workflow 200 for predicting displacement of fluid in a wellbore, in accordance with one or more examples. Workflow 200 may be used with workflow 100, for example, in substitution for block 108 of workflow 100. As illustrated, workflow 200 comprises blocks 202, 204, 206, and 208. In block 202, one or more velocity fields are updated. For example, one or more inputs to a neural network may be provided by block 202 and input into one or more PINNs. Specifically, the one or more PINNs may be used to replace the need for a fluid flow solution using projection methods with neural network-based techniques to estimate velocities and pressure. Two main embodiments are herein disclosed: first, that these one or more PINNs may predict fluid flow field at individual cross sections of an annulus; and second, that the one or more PINNs may predict the fluid flow field across a length of, e.g., entirety of, the wellbore annulus. Thus, the methods disclosed herein may involve, in some examples, using one or more PINNs to predict a velocity field at one or more annular cross-sections (e.g., annular cross-section 402 of FIG. 4) of a wellbore.

Block 204 involves advection calculations, which are performed to solve for fluid concentrations. In examples, these fluid concentrations are represented by advection diffusion-type partial differential equation. In some examples, the advection calculations may involve the use of steady advection diffusion, unsteady linear advection, unsteady non-linear burgers, an advection-diffusion equation with Dirichlet Boundary Conditions, physics-informed deep learning, combinations thereof, or the like.

In block 206, fluid properties are updated based on the calculated fluid concentrations. Blocks 202, 204, 206, and 208 may be performed iteratively for a plurality of annular cross-sections, such as by repeating one or more operations of workflow 200 at each annular cross-section. In some examples, in addition to looping through a plurality of annular cross-sections of a wellbore, calculations may be repeated (e.g., iteratively) for any given one or more annular cross-sections until a three-dimensional model reaches a steady state. “Steady state” in this context refers to the convergence of the various predictions to a stable, internally coherent, reliable, and generally reproducible output. The determination as to whether or not a prediction, calculation, or model has reached steady state may involve comparing the difference between a predicted output and physical solutions, in some examples.

In block 208, one or more PINNs may be used to predict velocity fields. An arrow between block 202 and block 208 shows that the PINNs of block 208 may be implemented with workflow 200 to predict new velocity fields based on updated velocity fields of block 202. Alternatively, the updated velocity fields of block 202 may depend on predictions of the PINNs in block 208. In yet other examples, the predictions of the one or more PINNs of block 208 may proceed directly to any of block 204, 206, or 110 such as, for example, when an error calculation of the predictions is less than a pre-determined threshold. Predictions by the PINNs of block 208 may be performed in various ways, to be discussed throughout this disclosure.

Once the predictive output for each cross-section has reached a steady state, the outputs for each annular cross-section may then be stitched together and used to render a three-dimensional model of a wellbore. As with FIG. 1, one or more operations of any of the blocks of workflow 200 may be performed by information handling system 112 (e.g., referring to FIG. 1), and which may be performed in a cloud computing environment.

In one or more examples, one or more operations of workflow 200 may involve comparing one or more predicted parameters (e.g., predicted fluid displacement) with one or more design parameter (e.g., target displacement) of block 102 (e.g., referring to FIG. 1) and adjusting one or more of the inputs of block 104 to re-run predictions with the one or more PINNs until the predicted parameter(s) match the design parameter(s). Thus, a method may involve comparing a predicted fluid displacement with a target displacement, in some examples, and modifying one or more virtual design parameters until the predicted parameter(s) converge on the design parameter(s). A cementing operation may be performed based on updated virtual design parameters, to be shown in later figures (e.g., FIGS. 12, 13).

FIG. 3 is a schematic 300 illustrating a wellbore 302 having a complex geometry, in accordance with one or more examples. As illustrated, wellbore 304 may have a complex geometry, extending down into a formation in a tortuous, meandering fashion, as illustrated. Wellbore 304 may comprise horizontal sections, slanted sections, as well as vertical sections. Accordingly, the casing 304 at any given location within the wellbore 304 may or may not be centralized within the wellbore 304 and may have a degree of standoff, for example, 0% standoff to about 100% standoff, or any ranges therebetween. As the velocity of a given region of a fluid being pumped between the casing 304 and a borehole wall of the wellbore 304 may vary depending on the standoff, the velocity profile of a fluid at a particular depth (e.g., annular cross-section 402 of FIG. 4) is influenced by the amount of standoff at that depth. In addition, these fluid dynamic effects may influence other properties, for example, the rate/amount of advection occurring within the fluid at a given region, and thus fluid concentrations, as well as other time-varying and spatially-varying fluid properties.

FIG. 4 illustrates a wellbore 302 divided into a plurality of annular cross-sections 402, in accordance with one or more examples. As with FIG. 3, a wellbore 302 may meanderingly and tortuously extend into a subterranean formation. As illustrated, a complex geometry of wellbore 302 may include, for example, a horizontal section 404 and/or one or more non-linearities 406 along a central axis of the wellbore 302, to use non-limiting examples. Also, a borehole wall of, and/or outer diameter of a casing disposed in, a wellbore 302 may have a non-uniform diameter depending on the specific depth or location at a given region of the wellbore 302. These and other factors complicate the fluid dynamics of the fluids that are pumped in the wellbore, for example, by introducing non-idealities to the system which render simplistic simulations inadequate to fully account for these effects. For example, predictions which assume 100% standoff, uniform-diameter along the entire length of the wellbores, perfectly vertical wellbores, etc., may not accurately predict the actual fluid dynamics of a fluid that is pumped into the wellbore 302.

To account for these non-idealities, the wellbore 302 is divided into a plurality of annular cross sections 402 so that the operations of one or more of the various workflows described herein are iteratively determined across the length of the wellbore 302 by performing calculations for each annular cross section 402. Dividing a wellbore annulus into a plurality of annular cross sections 402 may involve the use of a finite difference process and/or volume discretization process, in some examples, which may be part of the numerical solutions. It should be understood that while the “annular cross-sections” are shown and described herein as generally symmetrical, these may also exhibit irregularities (e.g., asymmetric annular cross-section), such as by involving concentric circles or ellipses with unaligned center points, or cross sections which are characterized by having two radii or major and minor axes, causing the shape to be lopsided or uneven at a particular depth point along the length of the wellbore. As with other non-idealities, such irregularities may have effects on the fluid dynamics of the wellbore which may be predicted and accounted for by the pre-trained PINNs.

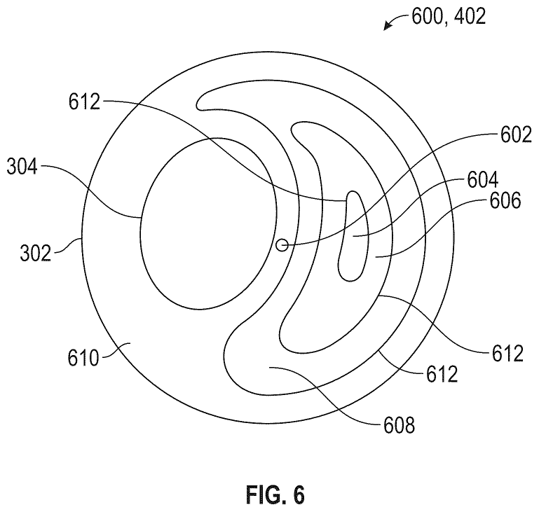

FIG. 5 illustrates a workflow 500 which uses steady state, pre-trained PINNs to predict velocity fields of fluids of one or more annular cross-sections of a wellbore, in accordance with one or more examples. As used in this context, “steady state” refers to achieving a converged solution at a given time step. For a transient problem, these predictions are performed for a plurality of time steps by breaking the transient problem down into smaller time seps. In the illustrated example, workflow 500 comprises Neural Network 502, PDE block 504, residual block 506, decision block 508, and output block 510. Inputs to Neural Network 502 may comprise any of the inputs of block 104 (e.g., referring to FIG. 1), such as viscosity and density of a wellbore fluid in one example. In the illustrated embodiment, inputs, i.e., “X₁ and X₂,” are shown as being input into the Neural Network 502. X₁ and X₂ may comprise, for example, one or more values, vectors, matrices, etc., which may each contain one or more of the inputs. The Neural Network 502 may also comprise a plurality of hidden layers, each comprising a plurality of nodes, or neurons, i.e., each represented as “o”. While only two hidden layers are shown in the illustrated example, each comprising four nodes, it should be understood that any suitable number of layers and/or nodes may be used. The Neural Network 502 may output one or more outputs, i.e., “u₁, u₂,” which may be used as inputs in PDE block 504. It should be understood that Neural Network 502 may have various suitable architectures, for example, multi-layer perceptron, convolutional neural network, or a recurrent neural network.

PDE block 504 may comprise one or more partial differential equations (PDEs). For example, a model of PDE block 504 may depend on vectorized Navier-Stokes Equations 1 and 2. Equation 3 is a species transport equation in Cartesian coordinates in a domain formed by the wellbore annulus.

$$∇ \cdot ( ρ u ) = 0 \qquad Equation l$$

where ∇ is a gradient operator, ρ is density, and u is output.

$$ρ \cdot \frac{\partial u}{\partial t} + ( u \cdot ∇ ) u = - ∇ p + ∇ τ + ρ \cdot g \qquad Equation 2$$

where ∇ is a gradient operator, ρ is density, u is output, t is time, τ is stress, and g is gravity.

$$\frac{\partial {c}_{i}}{\partial t} + ( u \cdot ∇ ) {c}_{i} = D \cdot {∇}^{2} {c}_{i} \qquad Equation 3$$

where cᵢ is concentration of a species, t is time, u is output (e.g., velocity), and D is a diffusion coefficient.

The aim of the model is to capture the transient, three-dimensional, incompressible, and laminar fluid flow, while injecting different fluids in the annulus. This calculates the time-evolution and distribution of the fluids' concentrations (and hence, the interfaces), using Equations 1, 2, and 3. The relationship between the deviatoric stress tensor (τᵢⱼ) and the strain rate tensor (Eᵢⱼ) is given by Equations 4 and 5. The apparent viscosity may vary in space and depends on the rheological model used, geometry parameters, the applied pressure gradient, or the fluid flow rate.

$${τ}_{ij} = 2 {μ}_{app} ( \dot{γ} ) {E}_{ij} \qquad Equation 4$$

where μₐₚₚ is the apparent viscosity as a function of the shear rate (\dot{γ}).

$$\vert \dot{γ} \vert = \sqrt{2 ( {E}_{ij} : {E}_{ij} )} \qquad Equation 5$$

where \dot{γ} is the shear rate and Eᵢⱼ is a strain rate tensor.

Non-limiting examples of physical variables which may be represented by one or more outputs of a PDEs of PDE block 504 may comprise for example, displacement, velocity, concentration, and combinations thereof. At residual block 506, a residual function quantifies errors between predictions of Neural Network 502 and values obtained from the physics-based calculations, e.g., PDEs, of differential equation block 504. These “loss” or “residual” calculations may use inputs and predicted outputs to apply mass balance and/or moment balance equations at each of a plurality of three-dimensional calculation nodes, in some examples. By applying physics-equations to residual calculations, workflow 500 ensures the predicted output satisfies the physical laws governing fluid flow.

In some examples, residual calculations at residual block 506 may comprise measuring error between predictions of the Neural Network 502 and actual data. “Actual data” in this context refers to data gathered by at least one sensor, e.g., downhole sensors, surface sensors, wellbore sensors, wireline tool sensor, EM logging tool, acoustic sensor, optical sensor, etc., and which may comprise any suitable wellbore measurement. Suitable wellbore measurements may include, for example, pressure, velocity, viscosity, rheology, or any suitable fluid property. One or more operations of residual block 506 may ensure that Neural Network 502 obeys the underlying PDEs and encourage the Neural Network 502 to produce solutions that conform closely to physics-based equations. In the illustrated example, residual block 506 is informed by one or more outputs of Neural Network 502. Dirichlet BCs 512 (Dirichlet Boundary Conditions) may be used in the error calculations of residual block 506, e.g., by comparing the solutions of PDEs of PDE block 504 against known measurements at one or more boundary points. In addition, residual block 506 may also be informed by one or more hidden layers of PDE block 504, which may employ one or more Neumann Boundary Conditions (Neumann BCs 512), or “flux boundary conditions,” in some examples. Neumann BCs 512, unlike Dirichlet BCs 512 which compares values of the PDE solutions at boundary points against known values at the boundary points, compares the derivative behavior of the solutions and measurements at the boundary points. For example, Neumann BCs 512 may be used to update residual block 506 by comparing the normal derivative of the solutions of PDEs of PDE block 504 against a known function representing flux, or derivative behavior, at the boundary points. Lastly, residual block 506 may also be informed or updated by equilibrium values 516 of PDE block 504, for example, when a prediction across numerous annular cross-sections 402 (e.g., referring to FIG. 4) has converged to a steady-state solution.

In one or more examples, workflow 500 may involve training one or more PINNs to minimize the difference between a predicted output of Neural Network 502 and output predicted using laws of physics. This may comprise, for example, ensuring that a predicted velocity field at a plurality of locations along a wellbore satisfy mass conservation and/or momentum conservation. In examples, PINNs may be used to learn relationships between velocity field and physical laws, and then use the learned relationships to predict velocity field at one or more other locations of the wellbore. Training one or more PINNs may be performed using training data, which may comprise using data from previous simulations in some examples, or may be alternatively be performed with little or no training data, to be discussed in greater detail.

Decision block 508 evaluates if the error determined by residual block 506 is of sufficiently low magnitude to yield a final output at output block 510 or else require one or more re-iterations of the operations of Neural Network 502 and PDE block 504. In the illustrated example, this determination is represented by “ϵ,” which represents a threshold error value above which reiteration with Neural Network 502 and PDE block 504 is triggered, or below which a final output is generated by workflow 500 at output block 510. The error “ϵ” may be specified to lower or higher tolerances depending on the desired resolution and/or precision of the output in output block 510. The final output of output block 510 may comprise, without limitation, any of the outputs listed herein, for example, predicted fluid velocity or velocity field of one or more fluids for one or more annular cross-sections 402 of a wellbore 302 (e.g., referring to FIG. 4). As with previous figures, one of more operations of any of the blocks of workflow 500 may be performed by an information handling system 112 (e.g., referring to FIG. 1), on a cloud computing environment, for example.

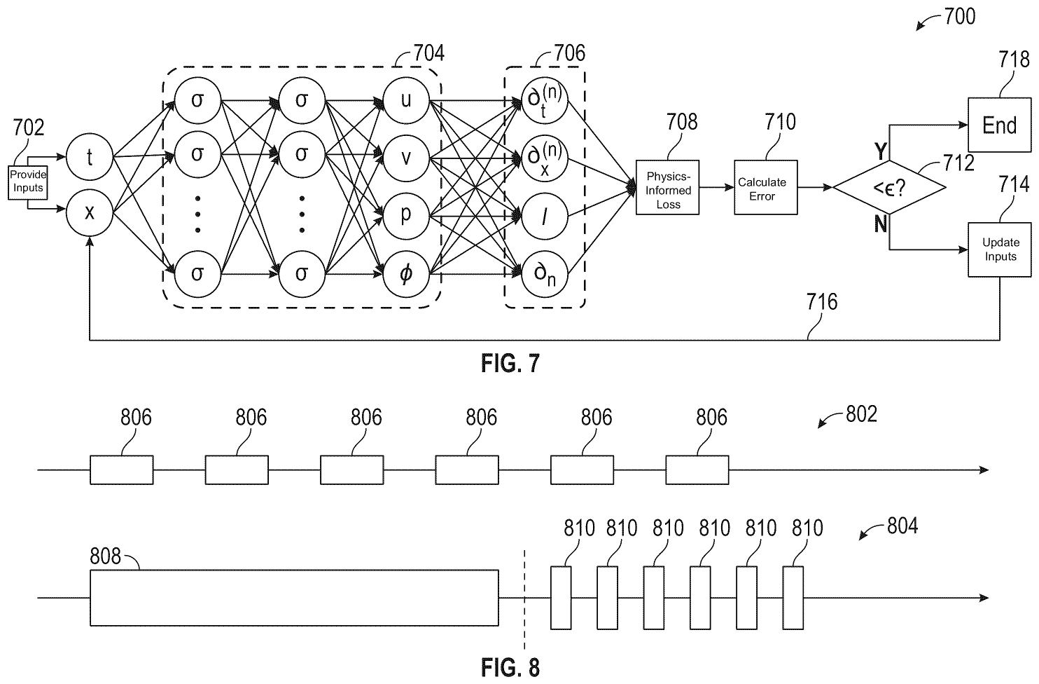

FIG. 6 is a schematic illustration of an output 600 for a single annular cross-section 402 of a wellbore 302, in accordance with one or more examples. In the illustrated example, the output 600 is an output of output block 510 of workflow 500 (e.g., referring to FIG. 5). In examples, however, output 600 may be alternatively, or additionally, characteristic of one or more intermediate and/or final outputs of any of workflows 100, 200, and 700 (e.g., referring to FIGS. 1, 2, 7), in some examples. As illustrated, a casing 304 may be situated within a wellbore 302 in such a way that it has a degree of offset, e.g., standoff, from a central axis 602 of the wellbore 302 at any given depth along the length of the wellbore 302. The wellbore 302 annular cross-section 402 may have a generally circular, ellipsoidal, or other geometric configuration adapted to represent the profile of the wellbore 302 at the appropriate depth represented by the annular cross-section 402. As alluded to previously, non-idealities such as standoff or irregular cross-sectional profile may cause significant variation of the velocity profile of the fluid at the various regions 604, 606, and 608 of a given annular cross-section 402. Output 600 may account for these different velocities, as well as other spatially- and/or time-varying parameters (e.g., concentration).

In this example, region 604 is characterized by a first velocity field value or range, region 606 by a second velocity field value or range, and region 608 by a third velocity field value or range. Differences in the predicted fluid velocities between these different regions 604, 606, and 608 may vary up to as much as 3 ft/sec (0.9 m/s) in some examples, depending on pumping rates, viscosity, density, etc. Boundaries 612 between the different regions 604, 606, 608, 610 may be used divide the annular cross-section 402 into a finite number of the regions 604, 606, 608, 610. However, more regions (e.g., greater than 3, 4, 5, 10, etc.) may yield higher-resolution predictions, though may impose a greater computation cost. Depending on available compute and desired resolution of a prediction, any suitable number of regions may be used, for example, between 2 and 100, or any ranges therebetween. In some examples, rather than velocity field, regions 604, 606, 608, and 610 may be used to alternatively represent fluid concentrations, pressure, displacement, or the like.

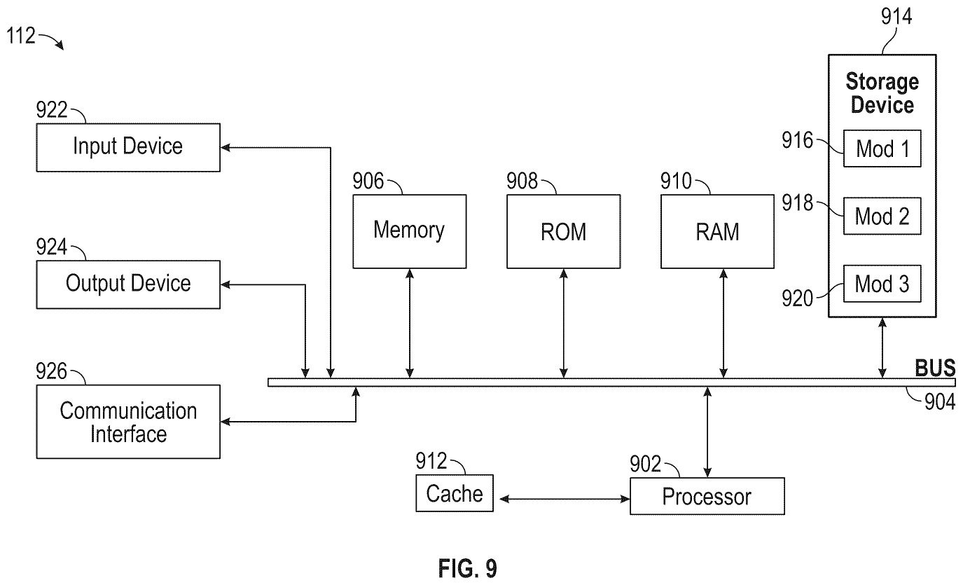

FIG. 7 illustrates a workflow 700 which uses PINNs to predict velocity fields of a wellbore 302, in accordance with one or more examples. In the illustrated example, workflow 700 comprises input block 702, Neural Network 704, automatic differentiation block 706, physics-informed loss block 708, error calculation block 710, decision block 712, and output block 718. Input block 702 comprises one or more inputs (e.g., t, x) to Neural Network 704. These inputs of input block 702 may comprise any of the inputs previously described by this disclosure, for example, any inputs used in workflow 500 (e.g., referring to FIG. 5). Similarly, Neural Network 704 may function in a manner similar to that of Neural Network 512, however, workflow 700 is configured to make long short-term memory (LSTM) predictions using steady state PINN, which may be time-varying in some examples. Use of an LSTM PINN may, in some examples, help to resolve a vanishing gradient problem and help the PINNs learn and remember information from the distant past, thus making them better equipped to perform time-series analysis. Where used, an LSTM PINN may involve a cell state, three gates, and a hidden state. The three gates may comprise forget gates, input gates, and output gates which: determine if information should be forgotten or retained; update the cell state with new information; and control what part of a cell state should be revealed as output, respectively, in some examples. Alternatives to LSTM may comprise, in some examples, Gated Recurrent Units (GRUs), and transformers. Alternatively, Bidirectional Recurrent Neural Networks (BRNNs), Echo State Networks (ESNs), Neural Ordinary Differential Equations (ODE-Nets), Long Short-Term Memory with Peephole Connections, Clockwork Recurrent Neural Networks, Hierarchical Recurrent Neural Networks, Recurrent Highway Networks, Federated Recurrent Neural Networks, LSTM Variants (e.g., Nested LSTMS, Clockwork LSTMS, etc.), and combinations thereof, to use non-limiting examples.

Neural Network 704 may comprise an input layer, e.g., “t and x”, an output layer, e.g., “u, ν, ρ, φ,” and any suitable number of hidden layers comprising any number of nodes, or neurons i.e., “σ.” As illustrated, the one or more outputs of the output layer are used by automatic differentiation block 706, which automatically computes derivatives. These derivatives may provide exact derivatives numerically. Following automatic computation of derivatives in automatic differentiation block 706, the derivatives are inputted into a physics informed physics-informed loss block 708, which calculates various losses. These losses may include, to use non-limiting examples, one or more of Equations 6-9. Equations 6-9 are various loss equations.

$${L}_{PDE} = f ( \hat{u} , {\partial }_{t} \hat{u} , {\partial }_{x} \hat{u} , … , λ ) \qquad Equation 6$$

$${{L}_{Data} = \hat{u} {\vert}_{Ω} - u \vert}_{Data} \qquad Equation 7$$

$${{L}_{IC} = \hat{u} {\vert}_{Ω , {t}_{0}} - g \vert}_{Ω , {t}_{0}} \qquad Equation 8$$

$${{{L}_{BC} = ( {\partial }_{n} \hat{u} {\vert}_{\partial Ω} - {\partial }_{n} g \vert}_{\partial Ω} ) + ( \hat{u} {\vert}_{\partial Ω} - g \vert}_{\partial Ω} ) \qquad Equation 9$$

Where L_{PDE} is a residual function for one or more PDEs, and L_{Data} is a residual function for this loss term which includes sensor data at sparse locations in the wellbore available from sensors placed in the field on the wellbore. L_{IC} is a residual function for initial conditions, L_{BC} is a residual function for boundary conditions, û represents variables in the PDE, ∂ₜ û represents temporal derivatives in the PDE, ∂ₓ û represents spatial derivatives of the variables in the PDE, λ represents parameters in the PDE, Ω is a spatial location, t₀ is an initial time, g is a value of a variable specified as a Dirichlet boundary condition or the Neumann boundary conditions, and n represents the direction of the derivative term, i.e. in the normal direction.

Physics-informed loss block 708 may function in a similar way as residual block 506 and may thus rely on the principles of physics to determine the loss. In error calculation block 710, the losses are added together to determine a total loss, which is used in decision block 712 to determine whether or not additional iterations of the workflow 700 are required or if the workflow 700 may proceed to output block 718. Where it is determined that an additional iteration of the workflow 700 is required, one or more inputs of block 712 may be updated in block 714 and re-input into the Neural Network 714, as illustrated by the arrow at 716. As many iterations may be performed as necessary to converge to a steady state. Updated inputs of block 714 may comprise, for example, 2 and 0, which represent parameter coefficients in a PDE. These parameter coefficients may comprise viscosity and diffusion coefficient, to use non-limiting examples.

Error calculation block 710 may add the different residual functions together or may alternatively assign one or more channel weights to one or more of the residual functions to prioritize a function which employs a particular physics model, or actual data, for example. Where used, the value of these channel weights, as well as other metadata (e.g., regularization parameters, calibration constants, initial guesses, etc., or other metadata commonly associated with machine learning techniques) of a Neural Network may be pre-determined beforehand or may be identified using a separate machine learning model in some examples. Use of a separate machine learning model to determine hyperparameters of the one or more PINNs may have the benefit of accelerating the rate that the PINNs learn the appropriate relationships between features evaluated by the PINNs. Decision block 712 may function similarly to decision block 508 (e.g., referring to FIG. 5) by comparing a total loss value to a preset value €. The output of output block 718 may comprise, in one or more examples, velocity field of one or more fluids in a wellbore 302 (e.g., referring to FIG. 3). Alternatively, displacement or concentrations of one or more fluids, to use non-limiting examples. For example, workflow 700 may be modified such that concentration fields are output for each of a plurality of annular cross-sections, in accordance with some examples. As with previous figures, one of more operations of any of the blocks of workflow 500 may be performed by an information handling system 112 (e.g., referring to FIG. 1).

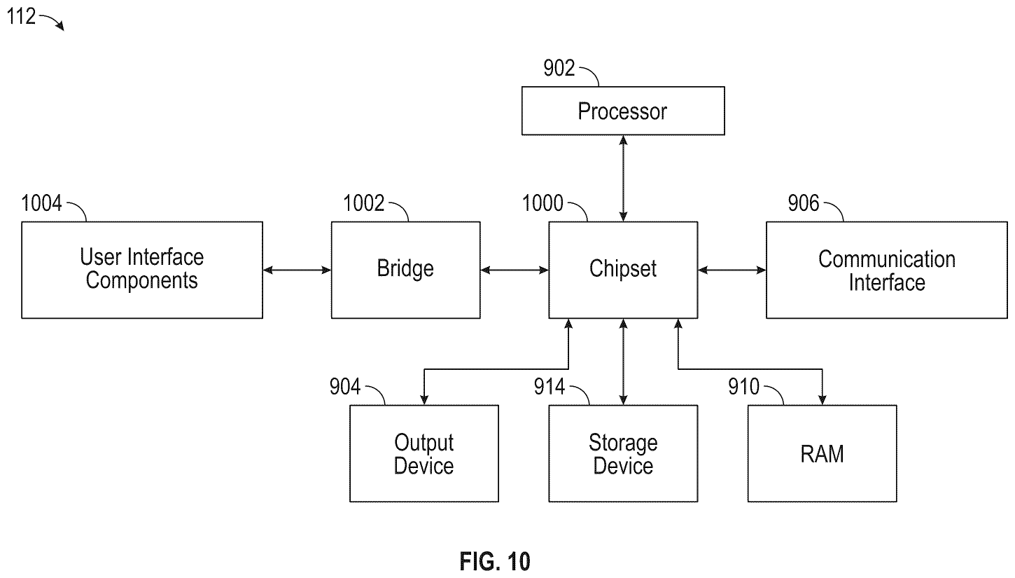

FIG. 8 illustrates a schematic of timelines 802, 804 comparing computational run-time of a three-dimensional displacement model and a method which uses physics informed neural networks, in accordance with one or more examples. It should be understood that the schematic illustration of this figure is not to scale necessarily but is intended only to show generally how the teachings and principles as applied here in may significantly improve the run-time of a computation. Timeline 802 shows the run-time of a three-dimensional model which does not use PINNs. As illustrated, the different stages 806 of timeline 802 span a substantial length of the timeline. Timeline 804 shows the run-time of a method which does use one or more PINNs. As illustrated, the stages 810 occupy only a fraction of what training stage 806 occupy with respect to timelines 802, 804, respectively.

PINNs are trained in stage 806 to mimic solutions of systems of partial differential equations representing physical phenomena such as, to use non-limiting examples, momentum balances, mass balances, energy balances, Navier-Stokes Equations, Euler Equations, Reynolds-Averaged Navier Stokes equations, Large Dddy simulations, Boussinesq equations, Lattice Boltzmann Methods, Boundary Element Methods, Smoothed Particle Hydrodynamics, Magnetohydrodynamics equations, Non-Newtonian Fluid Models, or other analogous systems for performing computational fluid dynamics. During training in training stage 806, the PINNs are taught to produce outputs that adhere closely to the physical solutions. Thus, the differences between predictions of the PINNs and solutions to the partial differential equations are minimized. As solving the partial differential equations, themselves may be time-consuming, it is advantageous to train the PINNs to mimic the solutions without actually requiring a computer or an engineer to derive analytical, or computational, solutions to the equations each time a simulation is performed. Thus, in general, training data used to train the one or more PINNs of the present disclosure may comprise solutions to systems of partial differential equations. This may involve actually running computer simulations to generate synthetic data (i.e., “simulated data”) comprising numerical solutions to systems of partial differential equations.

In other examples, a PINN may not necessarily have been trained using simulation data. The physics-specified in the loss term may help an individual PINN to predict the flow field, with little to no training data. Thus, a PINN may be trained without training data, in some examples, in the traditional sense that neural networks are trained on training datasets. However, simulation data may be included at some locations in a loss term (i.e., L_{Data} of Equation 7), which may help train the PINN faster. Thus, “pre-trained” as used herein, has more to do with input features seen by the neural networks, for example, wellbore orientation, shapes and sizes, varying fluid viscosities, varying number of fluids pumped, etc., and not synthetic data necessarily. During the training phase (e.g., stage 806 of FIG. 8), the PINNs are subjected to these varying features, ultimately allowing the PINNs to converge on a set of weights which may be later used during real-time evaluation.

In other examples, the synthetic data may be supplemented by or calculated using actual wellbore data. However, these examples still differ from traditional methods driven by non-physics-informed neural networks in that the training data is at least dominated by solutions to equations representing the physical phenomena rather than consisting entirely of real, measurement data. Synthetic data may comprise, to use non-limiting examples, concentration fields, velocity fields, fluid pressures, and/or displacement calculated for a plurality of annular cross-sections of a real or imaginary wellbore, for example. Synthetic data may be time-varying and thus account for time-evolving fluid dynamics, which may be learned by the one or more PINNs as a result of training in stage 806. Synthetic data may be calculated using traditional computational fluid dynamics modeling techniques and may be derived at least in part from actual wellbore data in some examples.

The specific types of training data used to train a particular type of PINN may vary depending on the type of output expected for a workflow. For example, a PINN that is used to predict fluid concentrations may be trained using a dataset comprising fluid concentration vectors calculated at each point within a three-dimensional space or boundary using a momentum balance, for example. Depending on the available computational power and/or desired resolution of a training dataset, grid size of the simulation may be adjusted to ensure accuracy of the predictions. In examples, a single PINN may be trained on a dataset that comprises several, e.g., hundreds, of prior simulations of real or imaginary wellbores, each having a unique wellbore geometry, pump schedule, type and/or order of introduced wellbore fluids, cement geometry, fluid property, bottom hole temperature, wellbore standoff, etc., or other wellbore parameter which could influence the fluid dynamics of a cementing operation.

As used herein, “off-line training” refers to training the one or more PINNs using a fixed dataset, and without making real-time adjustments or updates to the fixed dataset during the off-line training. For a single PINN, for example, the entire training dataset used to train the PINN is available from the start of training of the PINN until the pre-trained PINN is trained. A pre-trained PINN that was trained off-line is not precluded from being re-trained later. Where applicable, re-training of a pre-trained PINN may be performed on-line and/or off-line, such as by involving multiple training stages. “Off-line training” may also be referred to herein as “batch learning.”

As used herein, “on-line training” refers to training the one or more PINNs using a dynamic dataset, wherein real-time adjustments or updates are made to the dynamic dataset. For a single PINN, for example, the entire training dataset used to train the PINN is not necessarily available from the start of training of the PINN until the pre-trained PINN is trained. A pre-trained PINN that was trained on-line is also not precluded from being re-trained later. “On-line training” may also be referred to herein as “incremental learning,” or “real-time learning.” Online training may have the benefit of low latency, meaning that it may learn and respond immediately to new data as model parameters are updated continuously. On-line training may be performed in a cloud computing environment in some examples.

FIG. 9 illustrates an example information handling system 112 which may be employed to perform various steps, methods, and techniques disclosed herein. Persons of ordinary skill in the art will readily appreciate that other system examples are possible. As illustrated, information handling system 112 includes a processing unit (CPU or processor) 902 and a system bus 904 that couples various system components including system memory 906 such as read only memory (ROM) 908 and random-access memory (RAM) 910 to processor 902. Processors disclosed herein may all be forms of this processor 902. Information handling system 112 may include a cache 912 of high-speed memory connected directly with, in close proximity to, or integrated as part of processor 902. Information handling system 112 copies data from memory 906 and/or storage device 914 to cache 912 for quick access by processor 902. In this way, cache 912 provides a performance boost that avoids processor 902 delays while waiting for data. These and other modules may control or be configured to control processor 902 to perform various operations or actions. Another system memory 906 may be available for use as well. Memory 906 may include multiple different types of memory with different performance characteristics. It may be appreciated that the disclosure may operate on information handling system 112 with more than one processor 902 or on a group or cluster of computing devices networked together to provide greater processing capability. Processor 902 may include any general-purpose processor and a hardware module or software module, such as first module 916, second module 918, and third module 920 stored in storage device 914, configured to control processor 902 as well as a special-purpose processor where software instructions are incorporated into processor 902.

Processor 902 may be a self-contained computing system, containing multiple cores or processors, a bus, memory controller, cache, etc. A multi-core processor may be symmetric or asymmetric. Processor 902 may include multiple processors, such as a system having multiple, physically separate processors in different sockets, or a system having multiple processor cores on a single physical chip. Similarly, processor 902 may include multiple distributed processors located in multiple separate computing devices but working together such as via a communications network. Multiple processors or processor cores may share resources such as memory 906 or cache 912 or may operate using independent resources. Processor 902 may include one or more state machines, an application specific integrated circuit (ASIC), or a programmable gate array (PGA) including a field PGA (FPGA).

Each individual component discussed above may be coupled to system bus 904, which may connect each and every individual component to each other. System bus 904 may be any of several types of bus structures including a memory bus or memory controller, a peripheral bus, and a local bus using any of a variety of bus architectures. A basic input/output (BIOS) stored in ROM 908 or the like, may provide the basic routine that helps to transfer information between elements within information handling system 112, such as during start-up. Information handling system 112 further includes storage devices 914 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 914 may include software modules 916, 918, and 920 for controlling processor 902. Information handling system 112 may include other hardware or software modules. Storage device 914 is connected to the system bus 904 by a drive interface. The drives and the associated computer-readable storage devices provide nonvolatile storage of computer-readable instructions, data structures, program modules and other data for information handling system 112. In one aspect, a hardware module that performs a particular function includes the software component stored in a tangible computer-readable storage device in connection with the necessary hardware components, such as processor 902, system bus 904, and so forth, to carry out a particular function. In another aspect, the system may use a processor and computer-readable storage device to store instructions which, when executed by the processor, cause the processor to perform operations, a method, or other specific actions. The basic components and appropriate variations may be modified depending on the type of device, such as whether information handling system 112 is a small, handheld computing device, a desktop computer, a computer server, or a cloud infrastructure. When processor 902 executes instructions to perform “operations”, processor 902 may perform the operations directly and/or facilitate, direct, or cooperate with another device or component to perform the operations.

As illustrated, information handling system 112 employs storage device 914, which may be a hard disk or other types of computer-readable storage devices which may store data that are accessible by a computer, such as magnetic cassettes, flash memory cards, digital versatile disks (DVDs), cartridges, random access memories (RAMs) 910, read only memory (ROM) 908, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 112, an input device 922 represents any number of input mechanisms, such as a microphone for speech, a touch-sensitive screen for gesture or graphical input, keyboard, mouse, motion input, speech and so forth. Additionally, input device 922 may take in data from one or more downhole sensors, discussed above. An output device 924 may also be one or more of a number of output mechanisms known to those of skill in the art. In some instances, multimodal systems enable a user to provide multiple types of input to communicate with information handling system 112. Communications interface 926 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 902, that is purpose-built to operate as an equivalent to software executing on a general-purpose processor. For example, the functions of one or more processors presented in FIG. 9 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 308 for storing software performing the operations described below, and random-access memory (RAM) 310 for storing results. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. Information handling system 112 may practice all or part of the recited methods, may be a part of the recited systems, and/or may operate according to instructions in the recited tangible computer-readable storage devices. Such logical operations may be implemented as modules configured to control processor 902 to perform particular functions according to the programming of software modules 916, 918, and 920.

In examples, one or more parts of the example information handling system 112, up to and including the entire information handling system 112, may be virtualized. For example, a virtual processor may be a software object that executes according to a particular instruction set, even when a physical processor of the same type as the virtual processor is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization computer layer may operate on top of a physical computer layer. The virtualization computer layer may include one or more virtual machines, an overlay network, a hypervisor, virtual switching, and any other virtualization application.

FIG. 10 illustrates an example information handling system 112 having a chipset architecture that may be used in executing the described method and generating and displaying a graphical user interface (GUI). Information handling system 112 is an example of computer hardware, software, and firmware that may be used to implement the disclosed technology. Information handling system 112 may include a processor 902, representative of any number of physically and/or logically distinct resources capable of executing software, firmware, and hardware configured to perform identified computations. Processor 902 may communicate with a chipset 1000 that may control input to and output from processor 902. In this example, chipset 1000 outputs information to output device 924, such as a display, and may read and write information to storage device 914, which may include, for example, magnetic media, and solid-state media. Chipset 1000 may also read data from and write data to RAM 910. Bridge 1002 for interfacing with a variety of user interface components 1004 may be provided for interfacing with chipset 1000. User interface components 1004 may include a keyboard, a microphone, touch detection and processing circuitry, a pointing device, such as a mouse, and so on. In general, inputs to information handling system 112 may come from any of a variety of sources, machine generated and/or human generated.

Chipset 1000 may also interface with one or more communication interfaces 926 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 902 analyzing data stored in storage device 914 or RAM 910. Further, information handling system 112 receives inputs from a user via user interface components 1004 and executes appropriate functions, such as browsing functions by interpreting these inputs using processor 902.

In examples, information handling system 112 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

In examples, information handling system 112 may also include tangible and/or non-transitory computer-readable storage devices for carrying or having computer-executable instructions or data structures stored thereon. The non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

FIG. 11 illustrates an example of one arrangement of resources in a computing network 1100 that may employ the processes and techniques described herein, although many others are of course possible. As noted above, an information handling system 112, as part of their function, may utilize data, which includes files, directories, metadata (e.g., access control list (ACLS) creation/edit dates associated with the data, etc.), and other data objects. The data on the information handling system 112 is typically a primary copy (e.g., a production copy). During a copy, backup, archive or other storage operation, information handling system 112 may send a copy of some data objects (or some components thereof) to a secondary storage computing device 1104 by utilizing one or more data agents 1102.

A data agent 1102 may be a desktop application, website application, or any software-based application that is run on information handling system 112. As illustrated, information handling system 112 may be disposed at any rig site (e.g., referring to FIG. 1) or repair and manufacturing center. Data agent 1102 may communicate with a secondary storage computing device 1104 using communication protocol 1108 in a wired or wireless system. Communication protocol 1108 may function and operate as an input to a website application. In the website application, field data related to pre- and post-operations, generated DTCs, notes, and the like may be uploaded. Additionally, information handling system 112 may utilize communication protocol 1108 to access processed measurements, operations with similar DTCs, troubleshooting findings, historical run data, and/or the like. This information is accessed from secondary storage computing device 1104 by data agent 1102, which is loaded on information handling system 112.

Secondary storage computing device 1104 may operate and function to create secondary copies of primary data objects (or some components thereof) in various cloud storage sites 1106A-N. Additionally, secondary storage computing device 1104 may run determinative algorithms on data uploaded from one or more information handling systems 138, discussed further below. Communications between the secondary storage computing devices 1104 and cloud storage sites 1106A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 1106A-N, the secondary storage computing device 1104 may also perform local content indexing and/or local object-level, sub-object-level or block-level deduplication when performing storage operations involving various cloud storage sites 1106A-N. Cloud storage sites 1106A-N may further record and maintain DTC code logs for each downhole operation or run, map DTC codes, store repair and maintenance data, store operational data, and/or provide outputs from determinative algorithms that are run at cloud storage sites 1106A-N. In examples, computing network 1100 may be communicatively coupled to one or more downhole sensors. As previously described, information handling system 112 may be operable via telemetry techniques to receive downhole measurements at a surface.

An example technique and system for placing a cement composition into a subterranean formation will now be described with reference to FIGS. 12 and 13. As mentioned previously, cement may be pumped into a wellbore after fine-tuning the design parameters of a cementing operation according to any of the workflows previously disclosed. Such design parameters may include, for example, volume, pumping rate, pumping schedule, cement composition, combinations thereof, or the like. FIG. 12 illustrates surface equipment 1200 that may be used in placement of a cement composition in accordance with certain embodiments. It should be noted that while FIG. 12 generally depicts a land-based operation, those skilled in the art will readily recognize that the principles described herein are equally applicable to subsea operations that employ floating or sea-based platforms and rigs, without departing from the scope of the disclosure. As illustrated by FIG. 12, the surface equipment 1200 may include a cementing unit 1202, which may include one or more cement trucks. The cementing unit 1202 may include mixing equipment and pumping equipment as will be apparent to those of ordinary skill in the art. The cementing unit 1202 may pump a cement composition 1204 through a feed pipe 1206 and to a cementing head 1208 which conveys the cement composition 1204 downhole.

Turning now to FIG. 13, the cement composition 1204 may be placed into a subterranean formation 1302 in accordance with example embodiments. As illustrated, a wellbore 302 may be drilled into the subterranean formation 1302. While wellbore 302 is shown extending generally vertically into the subterranean formation 1302, the principles described herein are also applicable to wellbores that extend at an angle through the subterranean formation 1302, such as horizontal and slanted wellbores. In the illustrated embodiments, a surface casing 1304 has been inserted into the wellbore 302. The surface casing 1304 may be cemented to the walls 1306 of the wellbore 302 by cement sheath 1308. In the illustrated embodiment, one or more additional conduits (e.g., intermediate casing, production casing, liners, etc.) shown here as casing 304 may also be disposed in the wellbore 302. As illustrated, there is a wellbore annulus 1312 formed between the casing 304 and the walls 1306 of the wellbore 302 and/or the surface casing 1304. One or more centralizers 1314 may be attached to the casing 304, for example, to centralize the casing 304 in the wellbore 302 prior to and during the cementing operation.

With continued reference to FIG. 13, the cement composition 1204 may be pumped down the interior of the casing 1304. The cement composition 1204 may be allowed to flow down the interior of the casing 1304 through the casing shoe 1316 at the bottom of the casing 1304 and up around the casing 304 into the wellbore annulus 1312. The cement composition 1204 may be allowed to set in the wellbore annulus 1312, for example, to form a cement sheath that supports and positions the casing 304 in the wellbore 302. While not illustrated, other techniques may also be utilized for introduction of the cement composition 1204. By way of example, reverse circulation techniques may be used that include introducing the cement composition 1204 into the subterranean formation 1302 by way of the wellbore annulus 1312 instead of through the casing 304.

As it is introduced, the cement composition 1204 may displace other fluids 1318, such as drilling fluids and/or spacer fluids, that may be present in the interior of the casing 304 and/or the wellbore annulus 1312. At least a portion of the displaced fluids 1318 may exit the wellbore annulus 1312 via a flow line and be deposited, for example, in one or more retention pits (e.g., a mud pit), as shown on FIG. 12. Referring again to FIG. 13, a bottom plug 1320 may be introduced into the wellbore 302 ahead of the cement composition 1204, for example, to separate the cement composition 1204 from the fluids 1318 that may be inside the casing 304 prior to cementing. In other examples, fluids 1318 and cement composition 1204 may be in fluidic communication. After the bottom plug 1320 reaches the landing collar 1322, a diaphragm or other suitable device may rupture, in some examples, to allow the cement composition 1204 through bottom plug 1320. In FIG. 13, the bottom plug 1320 is shown on the landing collar 1322. In the illustrated embodiment, a top plug 1324 may be introduced into the wellbore 302 behind the cement composition 1204. The top plug 1324 may separate the cement composition 1204 from a displacement fluid 50 and also push the cement composition 1204 through the bottom plug 1320.

Specific improvements associated with some embodiments of the present disclosure may include, in some examples, an improved ability to design a cementing operation, improved accuracy of predictions while still maintaining low run-time, reduction in the need for time and expertise for designing the cementing operations, reduction in the number of redundancies and/or iterations in a workflow to converge to a solution, and a reduction or elimination in the number of intermediate solutions required to achieve an output. In some examples, improvements may comprise an ability to simulate three-dimensional displacement problems more quickly, which may allow engineers to perform more simulations and make better decisions about their designs. In some examples, improvements may enable real-time three-dimensional calculations. For example, this may enable engineers to visualize results of a simulation during rendering, thereby allowing them to better understand a problem and make more informed decisions. In some examples, other improvements may include an ability to perform sensitivity analysis and/or automated optimization. This may involve, for example, automating one or more operations of the workflows disclosed herein. Also, real-time availability of the predicted output using the one or more PINNs as disclosed herein may reduce the total amount of pumping time required to perform a cementing operation by accelerating the pumping schedule, which may result in being able to perform a cementing job in less than 24 hours, in some examples. Alternatively, less than 20 hours, less than 18 hours, or less than 16 hours, depending on the volume of cement and size of the wellbore, in some examples.

The disclosed cement may also directly or indirectly affect the various downhole equipment and tools that can come into contact with wellbore treatment fluids during operations. Such equipment and tools may include, without limitation, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), coupling (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described in the foregoing.

Accordingly, the present disclosure may provide methods and systems for using pre-trained physics informed neural networks for designing cementing jobs in wellbore operations. The method and systems may include any of the various features disclosed herein, including one or more of the following statements.

Statement 1: A method comprising: providing a pre-trained Physics-Informed Neural Networks (PINNs); providing one or more inputs to the one or more pre-trained PINNs; generating a time-varying predicted displacement using the one or more PINNs; comparing the time-varying predicted displacement with a target displacement; adjusting at least one of the one or more inputs and repeating the step of generating until the time-varying predicted displacement converges to the target displacement; and performing a cementing operation based at least in part on the one or more adjusted inputs.

Statement 2: The method of statement 1, wherein the one or more inputs comprise at least one input selected from the group consisting of a pump rate, a pump schedule, a pump volume, a fluid property, viscosity on a three-dimensional grid, density on a three-dimensional grid, fluid concentration on a three-dimensional grid, composition of a cement to be pumped into the wellbore, a wellbore geometry, an array of inner radii of a casing and/or borehole for a plurality of depths of the wellbore, an array of outer radii of a casing and/or borehole for the plurality of depths of the wellbore, an array of wellbore standoff for the plurality of depths of the wellbore, a gravity vector, grid size, and any combination thereof.

Statement 3: The method of statements 1 or 2, further comprising training one or more PINNs using at least a physics-informed loss function to form the one or more pre-trained PINNs, wherein the training comprises subjecting the one or more PINNs at least to a plurality of wellbore orientations, fluid viscosities, and number of fluids.

Statement 4: The method of statement 3, wherein the training the one or more PINNs further uses a loss term (L_{Data}) which comprises sensor data from one or more downhole sensors.

Statement 5: The method of statement 3, wherein the method further comprises re-training the one or more PINNs on-line if a calculated residual loss is greater than a predetermined limit.

Statement 6: The method of statement 3, wherein the training is performed off-line with a fixed dataset, and without making real-time adjustments or updates to the fixed dataset during the off-line training.

Statement 7: The method of any of statements 1-6, further comprising generating a time-varying predicted concentration field using the one or more pre-trained PINNs.

Statement 8: The method of any of statements 1-7, further comprising generating a time-varying velocity field using the one or more pre-trained PINNs.

Statement 9: The method of any of statements 1-8, wherein the one or more virtual design parameters comprise at least one parameter selected from the group consisting of a pump rate, cement volume, cement composition, and any combination thereof.

Statement 10: The method of statement 9, further comprising, based on the time-varying predicted displacement, modifying a pump schedule of at least one wellbore treatment fluid selected from the group consisting of a spacer fluid, a cement, a flush fluid, a pad fluid, an acid, a clean-up fluid, a wettability modifying fluid, a surfactant-based fluid, and any combination thereof.

Statement 11: The method of any of statements 1-10, further comprising displaying the time-varying prediction on a display device if the time-varying prediction reaches a steady state.

Statement 12: The method of any of statements 1-11, wherein the one or more pre-trained PINNs comprise one or more Long Short-Term Memory Physics-Informed Neural Networks (LSTM PINNs).

Statement 13: A method comprising: providing a pre-trained Physics-Informed Neural Networks (PINNs); inputting one or more inputs into the one or more pre-trained PINNs, wherein the one or more inputs comprise a viscosity vector, a density vector, or both; generating predicted fluid velocity fields for a plurality of annular cross-sections of a wellbore; modifying one or more design parameters of a cementing operation based at least in part on the predicted fluid velocity fields; and performing the cementing operation based at least in part on the one or more modified design parameters.

Statement 14: The method of statement 13, further comprising training one or more PINNs using at least a physics-informed loss function to form the one or more pre-trained PINNs, wherein the training comprises subjecting the one or more PINNs at least to a plurality of wellbore orientations, fluid viscosities, and number of fluids.

Statement 15: The method of statement 14, further comprising re-training the one or more pre-trained PINNs, wherein the re-training is performed online if a calculated residual loss is greater than a predetermined limit.

Statement 16: A method comprising: training one or more Neural Networks with one or more physics-informed loss functions to form one or more pre-trained Physics-Informed Neural Networks (PINNs); inputting one or more inputs into the one or more pre-trained PINNs, wherein the one or more inputs comprise a viscosity vector, a density vector, or both; predicting fluid pressures for a plurality of annular cross-sections of a wellbore; modifying one or more design parameters of a cementing operation based at least in part on the predicted fluid pressures; and performing the cementing operation based at least in part on the one or more modified design parameters.

Statement 17: The method of statement 16, wherein the training is performed off-line, wherein the method further comprises re-training the one or more pre-trained PINNs on-line if a calculated residual loss is greater than a predetermined limit.

Statement 18: A method comprising: providing one or more pre-trained Physics-Informed Neural Networks (PINNs); providing one or more virtual design parameters for a cementing operation; generating a model of at least a portion of a wellbore by inputting at least the one or more virtual design parameters into the one or more pre-trained PINNs, wherein the generating is performed in a cloud computing environment; displaying the model in real-time on a display device from the cloud computing environment; after displaying the model, modifying at least one of the one or more virtual design parameters; after modifying, repeating the step of generating but with the one or more modified virtual design parameters to form an updated model; repeating the step of displaying but with the updated model; and performing the wellbore cementing operation based on the one or more modified virtual design parameters.

Statement 19: The method of statement 18, wherein the one or more virtual design parameters comprise at least one parameter selected from the group consisting of pump rate, cement composition, pump schedule, volume, displacement, velocity, pressure, and any combination thereof, and wherein at least one of the steps of displaying, modifying, generating, and repeating is performed while cement is being actively pumped into a wellbore.

Statement 20: The method of statements 19, further comprising re-training the one or more pre-trained PINNs on-line if a calculated residual loss is greater than a predetermined limit.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited. Although specific examples have been described above, these examples are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but examples may provide some, all, or none of such advantages, or may provide other advantages.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design shown herein, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A method comprising:
providing a pre-trained Physics-Informed Neural Networks (PINNs);
providing one or more inputs to the one or more pre-trained PINNs;
generating a time-varying predicted displacement using the one or more PINNs;
comparing the time-varying predicted displacement with a target displacement;
adjusting at least one of the one or more inputs and repeating the step of generating until the time-varying predicted displacement converges to the target displacement; and
performing a cementing operation based at least in part on the one or more adjusted inputs.

2. The method of claim 1, wherein the one or more inputs comprise at least one input selected from the group consisting of a pump rate, a pump schedule, a pump volume, a fluid property, viscosity on a three-dimensional grid, density on a three-dimensional grid, fluid concentration on a three-dimensional grid, composition of a cement to be pumped into the wellbore, a wellbore geometry, an array of inner radii of a casing and/or borehole for a plurality of depths of the wellbore, an array of outer radii of a casing and/or borehole for the plurality of depths of the wellbore, an array of wellbore standoff for the plurality of depths of the wellbore, a gravity vector, grid size, and any combination thereof.

3. The method of claim 1, further comprising training one or more PINNs using at least a physics-informed loss function to form the one or more pre-trained PINNs, wherein the training comprises subjecting the one or more PINNs at least to a plurality of wellbore orientations, fluid viscosities, and number of fluids.

4. The method of claim 3, wherein the training the one or more PINNs further uses a loss term (L_{Data}) which comprises sensor data from one or more downhole sensors.

5. The method of claim 3, wherein the method further comprises re-training the one or more PINNs on-line if a calculated residual loss is greater than a predetermined limit.

6. The method of claim 3, wherein the training is performed off-line with a fixed dataset, and without making real-time adjustments or updates to the fixed dataset during the off-line training.

7. The method of claim 1, further comprising generating a time-varying predicted concentration field using the one or more pre-trained PINNs.

8. The method of claim 1, further comprising generating a time-varying velocity field using the one or more pre-trained PINNs.

9. The method of claim 1, wherein the one or more virtual design parameters comprise at least one parameter selected from the group consisting of a pump rate, cement volume, cement composition, and any combination thereof.

10. The method of claim 9, further comprising, based on the time-varying predicted displacement, modifying a pump schedule of at least one wellbore treatment fluid selected from the group consisting of a spacer fluid, a cement, a flush fluid, a pad fluid, an acid, a clean-up fluid, a wettability modifying fluid, a surfactant-based fluid, and any combination thereof.

11. The method of claim 1, further comprising displaying the time-varying prediction on a display device if the time-varying prediction reaches a steady state.

12. The method of claim 1, wherein the one or more pre-trained PINNs comprise one or more Long Short-Term Memory Physics-Informed Neural Networks (LSTM PINNs).

13. A method comprising:
providing a pre-trained Physics-Informed Neural Networks (PINNs);
inputting one or more inputs into the one or more pre-trained PINNs, wherein the one or more inputs comprise a viscosity vector, a density vector, or both;
generating predicted fluid velocity fields for a plurality of annular cross-sections of a wellbore;
modifying one or more design parameters of a cementing operation based at least in part on the predicted fluid velocity fields; and
performing the cementing operation based at least in part on the one or more modified design parameters.

14. The method of claim 13, further comprising training one or more PINNs using at least a physics-informed loss function to form the one or more pre-trained PINNs, wherein the training comprises subjecting the one or more PINNs at least to a plurality of wellbore orientations, fluid viscosities, and number of fluids.

15. The method of claim 14, further comprising re-training the one or more pre-trained PINNs, wherein the re-training is performed online if a calculated residual loss is greater than a predetermined limit.

16. A method comprising:
training one or more Neural Networks with one or more physics-informed loss functions to form one or more pre-trained Physics-Informed Neural Networks (PINNs);
inputting one or more inputs into the one or more pre-trained PINNs, wherein the one or more inputs comprise a viscosity vector, a density vector, or both;
predicting fluid pressures for a plurality of annular cross-sections of a wellbore;
modifying one or more design parameters of a cementing operation based at least in part on the predicted fluid pressures; and
performing the cementing operation based at least in part on the one or more modified design parameters.

17. The method of claim 16, wherein the training is performed off-line, wherein the method further comprises re-training the one or more pre-trained PINNs on-line if a calculated residual loss is greater than a predetermined limit.

18. A method comprising:
providing one or more pre-trained Physics-Informed Neural Networks (PINNs);
providing one or more virtual design parameters for a cementing operation;
generating a model of at least a portion of a wellbore by inputting at least the one or more virtual design parameters into the one or more pre-trained PINNs, wherein the generating is performed in a cloud computing environment;
displaying the model in real-time on a display device from the cloud computing environment;
after displaying the model, modifying at least one of the one or more virtual design parameters;
after modifying, repeating the step of generating but with the one or more modified virtual design parameters to form an updated model;
repeating the step of displaying but with the updated model; and
performing the wellbore cementing operation based on the one or more modified virtual design parameters.

19. The method of claim 18, wherein the one or more virtual design parameters comprise at least one parameter selected from the group consisting of pump rate, cement composition, pump schedule, volume, displacement, velocity, pressure, and any combination thereof, and wherein at least one of the steps of displaying, modifying, generating, and repeating is performed while cement is being actively pumped into a wellbore.

20. The method of claim 18, further comprising re-training the one or more pre-trained PINNs on-line if a calculated residual loss is greater than a predetermined limit.
